(19) United States
(12) Patent Application Publication
(10) Pub. No.: US 2009/0153671 A1
(43) Pub. Date: Jun. 18, 2009

(54) IMAGE DISPLAY APPARATUS HAVING POINTING FUNCTION AND METHOD THEREOF

(75) Inventors: Ho-seop LEE, Seoul (KR); Yung-jun PARK, Yongin-si (KR); Jong-sul MIN, Hwaseong-si (KR); Myung-jae KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/164,439

(22) Filed: Jun. 30, 2008

(30) Foreign Application Priority Data
Dec. 14, 2007 (KR) 10-2007-0131129

(51) Int. Cl. H04N 5/225

(52) U.S. Cl. 348/207.1; 348/E05.024

(57) ABSTRACT

An image display apparatus and method having pointing function are provided. The apparatus includes a picture taking unit for taking a picture of not only visible ray image but also infra ray image, extracts control information to control the image display apparatus from the picture taken, and display the picture taken. therefore, it is possible to operate not only pointing function but also various kinds of function through the image display apparatus.

### CROSS-REFERENCE TO RELATED APPLICATION

This application claims priority from Korean Patent Application No. 10-2007-0131129 filed on Dec. 14, 2007 in the Korean Intellectual Property Office, the disclosure of which is incorporated herein by reference in its entirety.

### BACKGROUND OF THE INVENTION

1. Field of the Invention

The present invention relates to an image display apparatus having a pointing function and a method thereof, and more particularly to an image display apparatus having a pointing function and a method thereof in which the apparatus takes a picture of a position to which a user points using a camera and displays the result.

2. Description of the Prior Art

An image display apparatus such as a monitor receives an image signal from an external device such as a computer and displays the image. The image display apparatus is used for data searching, creating documents, making presentations, etc. If the image display apparatus has a pointing function of displaying the position to which a user points, then the user can use the image display apparatus more effectively at work.

FIG. 1A illustrates an image display apparatus having a pointing function according to a related art. The image display apparatus (20) of the related art may take a picture of an infrared ray image, which a remote controller (10) transmits, using a camera (30) and display the picture. The camera (30) has a filter which transmits only an infrared ray image, so it takes only pictures of infrared ray images. The remote controller (10) has an infrared ray transmitting unit, so a user may use the pointing function by pointing to a position in the image display apparatus (20) with the remote controller (10).

FIG. 1B is a wavelength range graph which illustrates a wavelength range taken by the camera of the image display apparatus having a pointing function according to a related art. The camera (30) can take pictures of only 940±40 nm wavelength images and cannot be used for motion recognition, face recognition, etc, so that camera (30) is used only for the pointing function, so its usage is very limited.

### SUMMARY OF THE INVENTION

An aspect of the present invention is to provide an image display apparatus, which takes pictures of not only infrared ray images but also visible ray images and provides not only a pointing function but also other functions, and a method thereof.

According to an aspect of the invention, there is provided an apparatus for displaying images which includes a picture taking unit which has a filter to transmit light of at least two wavelength ranges, a camera image processing unit which processes an image signal outputted from the picture taking unit and outputs control information, and a control unit which controls operation of the apparatus according to the control information. The picture taking unit may have a filter to transmit light in an infrared ray range and a visible ray range. The camera image processing unit may process the image signal, which is output by the picture taking unit, to be ready to display. And the camera image processing unit may extract an image signal in the infrared ray range among the image signal which is output by the picture taking unit, calculate pointing coordinates, and output the pointing coordinates as the control information. Or the camera image processing unit may extract an image signal in the infrared ray range and an image signal of skin color range which is adjacent to the image signal in the infrared ray range among the image signal which is output by the picture taking unit, calculate pointing coordinates, and output the calculated coordinates as the control information.

According to an aspect of the invention, it is desirable for the image display apparatus to comprise an external image receiving unit which receives an image signal provided by a broadcasting station or an external device, a display image processing unit which process the image signal, provided by a broadcasting station or an external device, to be ready to display, and a display unit which displays the image processed in the display image processing unit. It is desirable for the control unit to control the display image processing unit and the display unit to display additional image corresponding to pointing coordinates on the display unit, if the control information is the pointing coordinates. The filter may have higher light transmittance in the infrared ray range than light transmittance in the visible ray range.

According to an aspect of the invention, there is provided a pointing method of an image display apparatus which includes taking a picture through a filter transmitting light of at least two wavelength ranges, processing the picture taken and outputting control information, and controlling operation of the image display apparatus according to the control information. The filter transmits light of an infrared ray range and a visible ray range. The pointing method may further include processing the picture taken to be ready to display. The processing the picture taken and outputting the control information may include extracting a portion of an infrared ray range in the picture taken through a filter, calculating pointing coordinates, and outputting the pointing coordinates as the control information. Or the processing the picture taken and outputting the control information may include extracting a portion of an infrared ray range and a portion of a skin color range which is adjacent to the portion of infra ray range in the picture taken through a filter, calculating pointing coordinates, and outputting the pointing coordinates as the control information.

According to an aspect of the invention, it is desirable for the pointing method to further comprise receiving an image signal provided by a broadcasting station or an external device, processing the image signal, provided by a broadcasting station or an external device, to be ready to display, and displaying the processed image signal. And it is desirable to further comprise controlling additional image corresponding to pointing coordinates to be displayed, if the control information is the pointing coordinates. The filter may have higher light transmittance in the infrared ray range than light transmittance in the visible ray range.

According to an aspect of the invention, there is provided an apparatus for displaying images which includes an external image receiving unit which receives an image signal provided by a broadcasting station or an external device, a display image processing unit which processes the image signal, provided by a broadcasting station or an external device, to be ready to display, a display unit which displays the image processed in the display image processing unit, a picture taking unit which takes a picture of a pointing image which points to the image displayed on the display unit and outputs a pointing image signal, a camera image processing unit which processes the pointing image signal and calculates pointing coordinates, and a control unit which controls the display image processing unit and the display unit to display an image signal corresponding to the pointing coordinates with the image signal processed by the display image processing unit. The picture taking unit may take a picture through a filter which transmits light of at least two wavelength ranges. The picture taking unit may take a picture through a filter which transmits light of an infrared ray range and a visible ray range. Finally, the picture taking unit may take a picture through a filter which has higher light transmittance in the infrared ray range than light transmittance in the visible ray range.

### BRIEF DESCRIPTION OF THE DRAWINGS

The above and other aspect and features of the present invention will be apparent from the following detailed description taken in conjunction with the accompanying drawings, in which:

FIG. 1A illustrates an image display apparatus having a pointing function according to a related art;

FIG. 1B is a wavelength range graph which illustrates a wavelength range taken by a camera of an image display apparatus having a pointing function according to a related art;

FIG. 2 is a block diagram of an image display apparatus according to an exemplary embodiment of the present invention;

FIG. 3 and FIG. 4 are wavelength range graphs which illustrate wavelength ranges taken by a camera of an image display apparatus having a pointing function according to an exemplary embodiment of the present invention;

FIG. 5 is a block diagram of a camera image processing unit according to an exemplary embodiment of the present invention;

FIG. 6A to FIG. 6C are views explaining a method for calculating pointed coordinates according to an exemplary embodiment of the present invention;

FIG. 7 is a flow chart showing a method of calculating pointed coordinates according to an exemplary embodiment of the present invention; and

FIG. 8A to FIG. 8C are views explaining a method for calculating pointed coordinates according to another exemplary embodiment of the present invention.

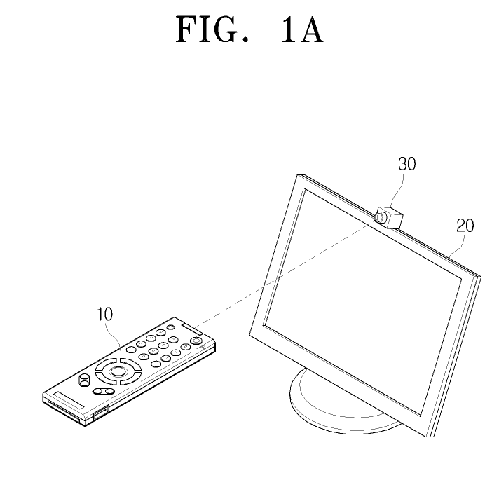

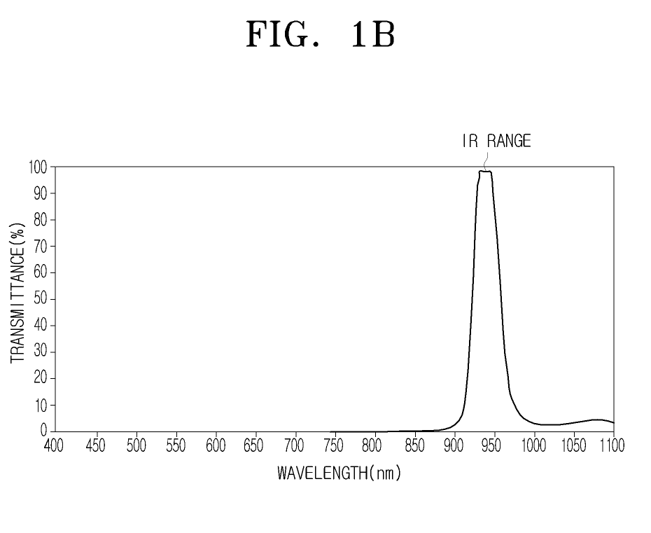

### DETAILED DESCRIPTION OF EXEMPLARY EMBODIMENTS OF THE INVENTION

Hereinafter, exemplary embodiments of the present invention will be described in detail with reference to the accompanying drawings. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are merely specific details provided to assist those of ordinary skill in the art in a comprehensive understanding of the invention, and the present invention is only defined within the scope of the appended claims.

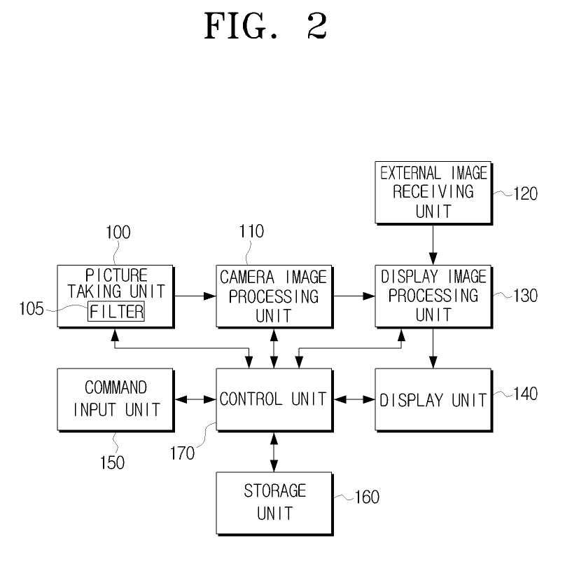

FIG. 2 is a block diagram of an image display apparatus according to an exemplary embodiment of the present invention.

The image display apparatus according to an embodiment of the present invention includes a picture taking unit 100, a camera image processing unit 110, an external image receiving unit 120, a display image processing unit 130, a display unit 140, a command input unit 150, a storage unit 160, and a control unit 170.

The picture taking unit 100 takes a picture of an incident optical image through a lens unit and produces a corresponding electrical image signal. The picture taking unit 100 provides a filter 105 which can transmit both an infrared ray image whose wavelength range is 940±40 nm and a visual ray image whose wavelength range is 380˜780 nm. The picture taking unit 100 takes a picture of infrared ray and visual ray optical images using the filter 105 and produces a corresponding electrical image signal.

The camera image processing unit 110 processes the image signal which is output by the picture taking unit 100 and sends the result to the display image processing unit 130 and the control unit 170. That is, the camera image processing unit 110 processes the image signal, which is output by the picture taking unit 100, extracts various kinds of control information for controlling operations of the image display apparatus from the processed image signal and sends the information to the control unit 170. The control information includes pointing coordinates calculated using the infrared ray image signal or calculated using the infrared ray image signal and the visible ray image signal of skin color together. After processing the image signal which is output by the picture taking unit 100, the camera image processing unit 110 sends the result to the display image processing unit 130 for displaying at the display unit 140.

The external image receiving unit 120 receives a broadcasting signal, demodulates the signal, corrects an error, and outputs a video signal, an audio signal, and a data signal separately. Also, the external image receiving unit 120 may receive and output the audio and video signals provided by an external device such as a DVD player or computer.

The display image processing unit 130 processes the image signal, which is output by the external image receiving unit 120, for displaying at the display unit 140, and the display image processing unit 130 also processes the image signal, which is output by the camera image processing unit 110, for displaying at the display unit 140. The display image processing unit 130 also adjusts an output status of the image signal displayed at the display unit 140 according to the control of the control unit 170. For example, the control unit 170 controls the display image processing unit 130 to display a pointing image according to the pointing coordinates outputted by the camera image processing unit 110.

The display unit 140 displays video data which is output by the display image processing unit 130 and various kinds of display modules such as a Digital Lighting Processing (DLP), a Liquid Crystal Display (LCD), a Plasma Display Panel (PDP), etc. may be used in the display unit 140.

The command input unit 150 includes keys for inputting a user's command to control operations of the image display apparatus and a receiver to receive a user's command transmitted from the remote controller (not illustrated). The user's command received though the command input unit 150 may be converted to a key signal and be sent to the control unit 170.

The storage unit 160 may store software and data which are needed to operate the image display apparatus, a video signal and an audio signal received through the external image receiving unit 120 according to a user's command, or an image signal taken by the picture taking unit 100.

The control unit 170 controls operations of the image display apparatus according to the user's command received through the command input unit 150 or the control information which is outputted from the camera image processing unit 110. That is, the control unit 170 controls the display image processing unit 130 to display the pointing image together with other images on the display unit 140 according to the pointing coordinates which are outputted from the camera image processing unit 110, and if the camera image processing unit 110 outputs control information by recognizing its environment, a user's motion, and a user's face, the control unit 170 controls the image display apparatus to operate according to the outputted control information.

In more detail, if the camera image processing unit 110 outputs control information by recognizing a user's motion, a user's presence, or a user's absence, the control unit 170 controls a display image processing unit 130 to adjust the brightness of the image signal displayed on the display unit 140 or controls the image display apparatus to operate in a power saving mode for reducing power consumption according to the control information. For example, if there is no motion of a user or a user is absent, the control unit 170 controls the image display apparatus to reduce the brightness or to operate in a power saving mode. And if a user's motion is detected, the control unit 170 controls the image display apparatus to operate in normal brightness or cancel the power saving mode.

Also, if the camera image processing unit 110 outputs control information by recognizing a user's gesture, the control unit 170 controls the image display apparatus according to the control information in a manner similar to that in which the control unit 170 controls the image display apparatus according to a user's command received though the command input unit 150. For example, if a user moves his hand clockwise, the control unit 170 controls the image display apparatus to change to a higher number channel, and if a user moves his hand counterclockwise, the control unit 170 controls the image display apparatus to change to a lower number channel.

If the camera image processing unit 110 outputs control information by recognizing a user's face, the image display apparatus will change its position to face toward the front of the user according to the control information. For example, if a user is at the right side of the image display apparatus so as to cause a reduced viewing angle, the control unit 170 controls the image display apparatus to turn toward the user to increase the viewing angle.

If the camera image processing unit 110 extracts control information by analyzing the environment, the control unit 170 controls hue, lightness, and saturation of the image displayed by the image display apparatus according to the control information.

As mentioned above, it is possible to take a picture of not only an infrared ray image but also a visible ray image using the picture taking unit 100, to display the images outputted from the picture taking unit 100 on the display unit 140, and to provide control information for controlling the image display apparatus.

In FIG. 2, if the remote controller having an infrared ray whose wavelength is 940 nm used, and so the filter 105 which can transmit an infrared ray image whose wavelength range is 940±10 nm is exemplified. However in some situations, the remote controller having an infrared ray whose wavelength is 840 nm can be used, and in this case the filter 105 which can transmit an infrared ray image whose wavelength range is 840±α nm can be used. As described above, design of the filter (105) can be modified according to the wavelength range of the remote controller.

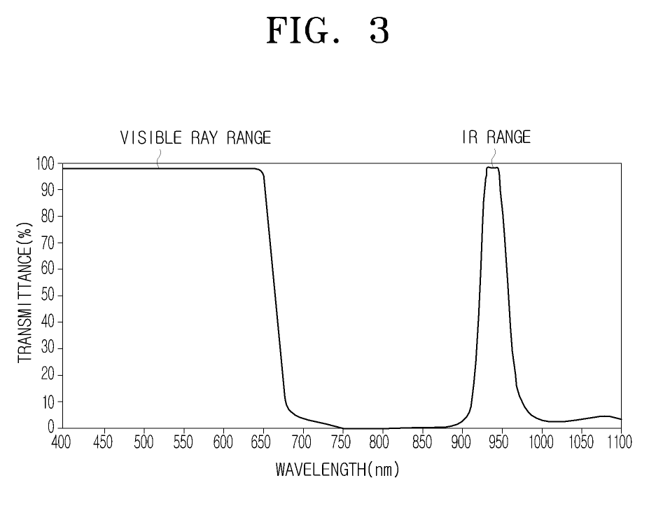

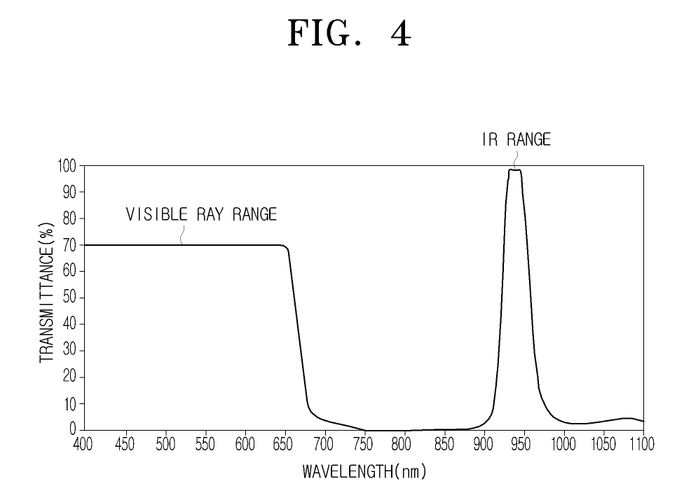

FIG. 3 and FIG. 4 are wavelength range graphs which illustrate wavelength ranges taken by a camera of an image display apparatus having a pointing function according to an exemplary embodiment of the present invention.

Referring to FIG. 3, it is desirable to design the filter 105 in the picture taking unit 100 which can transmit both over 90% of an infrared ray image whose wavelength range is 940±10 nm and a visual ray image whose wavelength range is 400˜650 nm.

Referring to FIG. 4, the filter 105 in the picture taking unit 100 which may be designed to transmit both over 90% of an infrared ray image whose wavelength range is about 940±10 nm and over 70% of a visual ray image whose wavelength range is 400˜660 nm. The transmittance of the infrared ray image is higher than that of the visual ray image in this case, so the visual ray image may be taken darker than infrared ray (IR) image. And it is possible to design the filter 105 to have a transmittance of over 70% or below 70%.

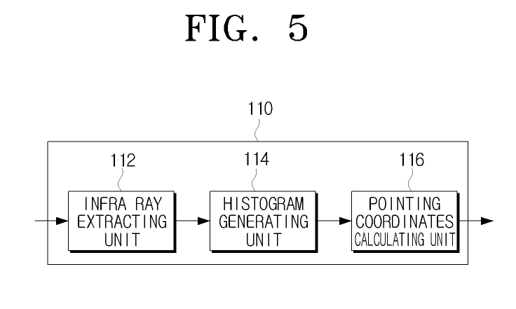

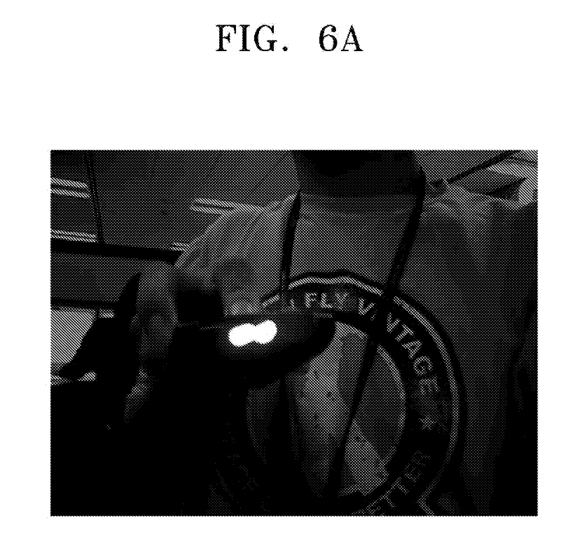

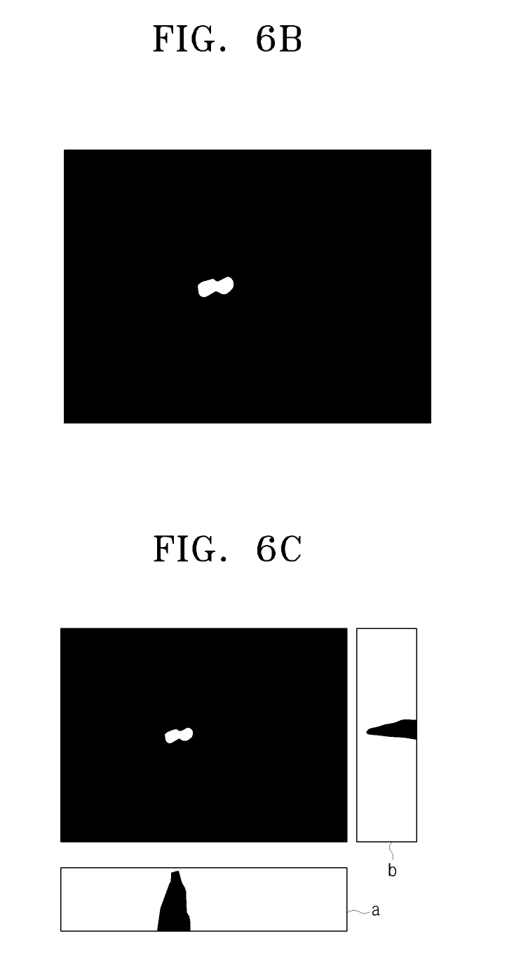

FIG. 5 is a block diagram of camera image processing unit according to an exemplary embodiment of the present invention, and FIG. 6A to FIG. 6C are views explaining a method for calculating pointed coordinates according to an exemplary embodiment of the present invention.

Referring to FIG. 5, the camera image processing unit 110 includes an infrared ray extracting unit 112, a histogram generating unit 114, and a pointing coordinates calculating unit 116.

The infrared ray extracting unit 112 extracts the infra ray image signal, using the transmittance of the filter 105, from the image signal taken through the filter 105 which has a characteristic shown in FIG. 4. That is, the infrared ray extracting unit 112 determines the area which is darker than the critical value as a visible ray area and the area which is brighter than the critical value as an infrared ray area, and outputs the image signal which is determined as the infrared ray area. In other words, the image of the infrared ray area is brighter than that of the visible ray area, as shown in FIG. 6A, among the image signal outputted from the picture taking unit 100, and the infrared ray extracting unit 112 extracts an infrared ray area image, as shown in FIG. 6B, using the value of brightness.

The histogram generating unit 114 generates a histogram of brightness in vertical and horizontal positions from the extracted image received from the infrared ray extracting unit 112. That is, as shown in FIG. 6C, the histogram generating unit 114 generates a histogram (a) of brightness in horizontal position and a histogram (b) of brightness in vertical position from the extracted image as the infrared ray area image.

The pointing coordinates calculating unit 116 calculates the pointing coordinates by calculating the coordinates of maximum frequency from the histogram. That is, the pointing coordinates calculating unit 116 calculates the horizontal coordinate having maximum frequency in the histogram (a) of brightness in horizontal position shown in FIG. 6C, and the vertical coordinate having maximum frequency in the histogram (b) of brightness in vertical position shown in FIG. 6C.

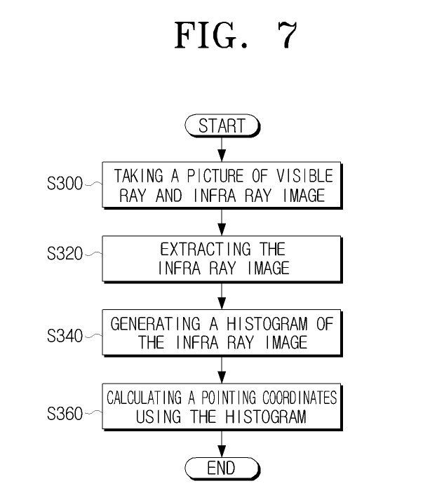

FIG. 7 is a flow chart showing a method of calculating pointing coordinates according to an exemplary embodiment of the present invention.

Referring to FIG. 7, the picture taking unit 100 takes pictures of visible ray and infrared ray images (S300). The camera image processing unit 110 extracts the infrared ray image from the pictures taken as shown in FIG. 6B (S320), generates a histogram of the infra ray image as shown in FIG. 6C (S340), calculates pointing coordinates using the histogram (S360). According to the steps above, it is possible to extract pointing coordinates using infra ray image taken with visible ray image.

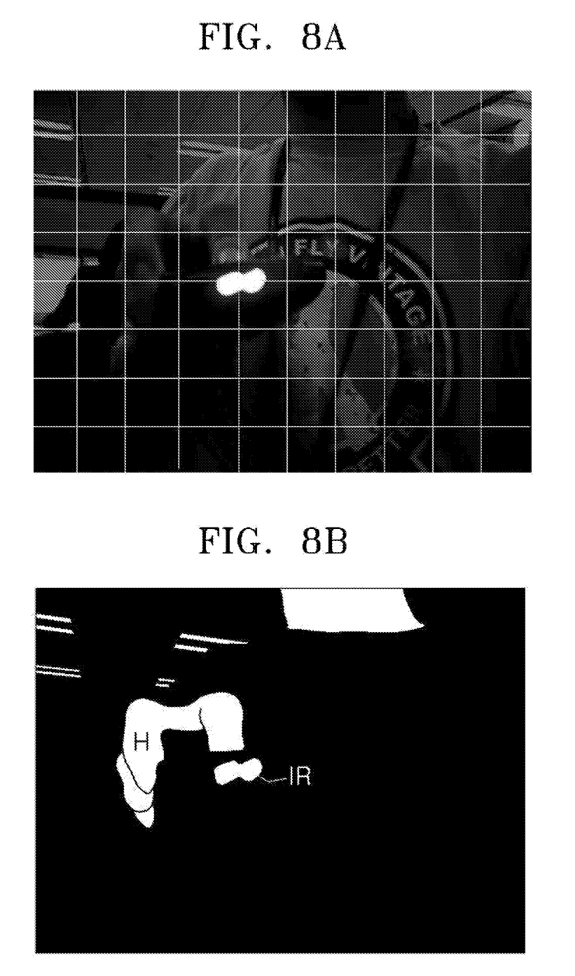

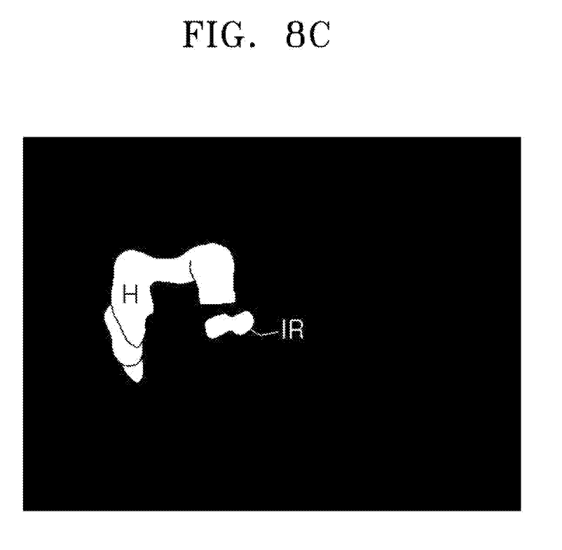

FIGS. 8A and 8B are views explaining a method for calculating pointing coordinates according to another exemplary embodiment of the present invention.

Referring to FIG. 8A, the image taken by the picture taking unit 100 is divided into a number of blocks, and an infrared ray area and a skin color area are extracted using hue and saturation information of pixels in each block. Referring to FIG. 8B, a fluorescent lamp area also may be extracted with the infrared ray area and the skin color area. Referring to FIG. 8C, the camera image processing unit 110 decides only an infrared ray area (IR) and a user's hand area (H) which is a skin color area which is close to the infra ray area (IR) as the pointing position and this makes it possible to calculate pointing coordinates exactly.

As mentioned above, the image display apparatus of this invention enables taking not only a picture of an infrared ray image, but also a picture of a visible ray image and displaying them. So the image display apparatus can be used for a video conference, taking a moving picture, taking a still picture, a mirror, etc.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An apparatus for displaying images, comprising:
a picture taking unit which has a filter to transmit light of at least two wavelength ranges;
a camera image processing unit which processes an image signal outputted from the picture taking unit and outputs control information; and
a control unit which controls operation of the apparatus according to the control information.

2. The apparatus of claim 1, wherein the filter transmits light of an infrared ray range and a visible ray range.

3. The apparatus of claim 1, wherein the camera image processing unit processes the image signal, which is output by the picture taking unit, to be ready to display.

4. The apparatus of claim 1, wherein the camera image processing unit extracts an image signal of an infrared ray range among the image signal which is output by the picture taking unit, calculates pointing coordinates, and outputs the pointing coordinates as the control information.

5. The apparatus of claim 1, wherein the camera image processing unit extracts an image signal of an infrared ray range and an image signal of skin color range which is adjacent to the image signal of the infrared ray range among the image signal which is output by the picture taking unit, calculates pointing coordinates, and outputs the pointing coordinates as the control information.

6. The apparatus of claim 1, further comprising:
an external image receiving unit which receives an image signal provided by a broadcasting station or an external device;
a display image processing unit which processes the image signal, provided by the broadcasting station or the external device, to be ready to display; and
a display unit which displays the image processed in the display image processing unit.

7. The apparatus of claim 6, wherein the control unit controls the display image processing unit and the display unit to display an additional image corresponding to pointing coordinates on the display unit, if the control information is the pointing coordinates.

8. The apparatus of claim 2, wherein the filter has higher light transmittance in the infrared ray range than light transmittance in the visible ray range.

9. A pointing method of an image display apparatus, comprising:
taking a picture through a filter transmitting light of at least two wavelength ranges;
processing the picture taken and outputting control information; and
controlling operation of the image display apparatus according to the control information.

10. The pointing method of claim 9, wherein the filter transmits light of an infrared ray range and a visible ray range.

11. The pointing method of claim 9, further comprising processing the picture taken to be ready to display.

12. The pointing method of claim 9, wherein the processing the picture taken and outputting the control information comprises extracting a portion of an infrared ray range in the picture taken through the filter, calculating pointing coordinates, and outputting the pointing coordinates as the control information.

13. The pointing method of claim 9, wherein the processing the picture taken and outputting the control information comprises extracting a portion of an infrared ray range and a portion of skin color range which is adjacent to the portion of the infrared ray range in the picture taken through the filter, calculating pointing coordinates, and outputting the pointing coordinates as the control information.

14. The pointing method of claim 9, further comprising:
receiving an image signal provided by a broadcasting station or an external device;
processing the image signal, provided by the broadcasting station or the external device, to be ready to display; and
displaying the processed image signal.

15. The pointing method of claim 14, further comprising controlling an additional image corresponding to pointing coordinates to be displayed, if the control information is the pointing coordinates.

16. The pointing method of claim 10, wherein the filter has higher light transmittance in the infrared ray range than light transmittance in the visible ray range.

17. An apparatus for displaying images, comprising:
an external image receiving unit which receives an image signal provided by a broadcasting station or an external device;
a display image processing unit which processes the image signal, provided by the broadcasting station or the external device, to be ready to display;
a display unit which displays the processed image in the display image processing unit;
a picture taking unit which takes a picture of a pointing image which points to the image displayed on the display unit and outputs a pointing image signal;
a camera image processing unit which processes the pointing image signal and calculates pointing coordinates; and
a control unit which controls the display image processing unit and the display unit to display an image signal corresponding to the pointing coordinates with the image signal received by the external image receiving unit.

18. The pointing method of claim 17, wherein the picture taking unit takes a picture through a filter which transmits light of at least two wavelength ranges.

19. The pointing method of claim 17, the picture taking unit takes a picture through a filter which transmits light of an infrared ray range and a visible ray range.

20. The pointing method of claim 17, wherein the picture taking unit takes a picture through a filter which has higher light transmittance in the infrared ray range than light transmittance in the visible ray range.
